(19) United States
(12) Patent Application Publication
(10) Pub. No.: US 2013/0230735 A1
(43) Pub. Date: Sep. 5, 2013

(54) METHOD FOR PRODUCING A CHANNEL ARRANGEMENT, A CHANNEL ARRANGEMENT, USE OF A CHANNEL ARRANGEMENT AND A METAL PROFILE

(71) Applicants: Hans Keife, Vasteras (SE); Petri Konttinen, Pori (FI); Anders Falkenö, Vasteras (SE)

(72) Inventors: Hans Keife, Vasteras (SE); Petri Konttinen, Pori (FI); Anders Falkenö, Vasteras (SE)

(21) Appl. No.: 13/819,863

(22) PCT Filed: Aug. 31, 2010
(86) PCT No.: PCT/EP2010/062666

§ 371 Date: May 10, 2013

(51) Int. Cl. B21C 37/14; B26D 7/27

(52) U.S. Cl. CPC B21C 37/14; B26D 7/27
USPC 428/593; 29/428

(57) ABSTRACT

A method for producing a channel arrangement, a channel arrangement, a metal profile and use of a channel arrangement. The method includes arranging a first metal profile towards a second metal profile. The first profile includes elongated trench-like portions mutually separated by flat portions. The first profile is joined to the second profile so that channels between the first profile and the second profile are defined. The channels are separated by flat regions. In the arranging, at least one of the profiles is a profile including an incipient cut to be located in at least one of the flat regions. Material is removed from the at least one flat region so that the thickness of a part of the at least one flat region becomes less than the sum of the thicknesses of the profiles.

### FIELD OF THE INVENTION

The present invention relates to a method for producing a channel arrangement. The method comprises the steps a) arranging a first metal profile towards a second metal profile, said first metal profile comprises elongated trench-like portions mutually separated by flat portions, and b) joining the first metal profile to the second metal profile so that channels between these profiles are defined, which channels extend according to said trench-like portions, said channels being separated by flat regions.

Furthermore, the present invention relates to a channel arrangement, use of a channel arrangement and a metal profile.

### PRIOR ART

A channel arrangement in here defined to comprise two or more channels separated by flat regions. The channel arrangement comprises preferably a material with high thermal conductivity, such as copper, aluminum, etcetera, wherein the flat regions are adapted to conduct heat to or from the channels. The channels are adapted to conduct a fluid, such as a cooling medium or a heat medium. Accordingly, the channel arrangement is adapted to absorb heat or radiate heat.

Such channel arrangements are used as heat exchangers in various technical applications, such as heat radiators in engines, computers, etcetera, and heat absorbers, such as in solar absorbers, etcetera.

The channels must have a material thickness that provides sufficient strength to maintain a certain pressure of the fluid within the channels. The flat regions between the channels must have a thickness that provides sufficient heat conduction rate to or from the channels. In most situations the desired pressure of the fluid within the channels requires a higher material thickness than the necessary material thickness of the flat regions.

Accordingly, a channel arrangement configured with higher material thickness of the channels than the material thickness of the flat regions provides a reduced material consumption for the channel arrangement with negligible reduction in performance when used in a heat exchanger. Furthermore, such channel arrangement has reduced weight.

In order to produce channel arrangement with complex geometry, such as channel arrangement where the material thickness of the channels is higher than the material thickness of the flat regions, extrusion is used. However, extrusion of channel arrangement is only possible for certain metals. For example, copper and copper alloys are difficult to extrude. Furthermore, the production rate by extruding channel arrangement may be insufficiently low for some metals.

In order to facilitate the manufacturing of channel arrangements of various types of metals a first metal profile and a second metal profile are used. The metal profiles are joined together by various joining methods, such as welding, rolling, etcetera.

A problem with manufacturing channel arrangement from the first and the second metal profile is that the material thickness of the channels is the same as the material thickness of the flat regions. Thereby, the channel arrangement is not using the material of the metal profiles optimally, which adds cost and weight to the channel arrangement.

EP1894660 discloses a method for manufacturing a channel arrangement by means of clad-rolling a first metal profile towards a second metal profile. Although their method is favorable and reliable, the manufactured channel arrangement is configured so that the material thickness of the channels is the same as the material thickness of the flat regions.

### OBJECTS AND SUMMARY OF THE INVENTION

The object of the present invention is to provide a method for producing a channel arrangement being improved in at least some aspect with respect to such methods already known. The object of the present invention is furthermore to provide an improved channel arrangement, use of the channel arrangement and an improved metal profile adapted to be manufactured into a channel arrangement.

This object is obtained by a method as defined by the preamble of claim 1, wherein the method is characterized by using in step a) as at least one of said profiles a profile comprising an incipient cut to be located in at least one said flat region, and by comprising a further step c) carried out after step b) of removing material from said at least one flat region by means of said incipient cut, so that the thickness of at least a part of said at least one flat region becomes less than the sum of the thicknesses of the first and the second metal profile.

The incipient cut is adapted to enable a removal of the material from said at least one flat region. Thereby, the material thickness of said at least one flat region is reduced while the material thickness of the channels are maintained. Accordingly, the method enables a channel arrangement to be produced with reduced material consumption. Furthermore, the weight of the manufactured channel arrangement is reduced.

The term “incipient cut” refers to an arranged weakening in the strength of the material of the metal profile as compared with the strength of the remaining part of the metal profile. Thereby, the incipient cut is adapted to enable material to be removed from the at least one flat region.

According to one embodiment of the invention, said incipient cut at least partly encloses the material to be removed. Thereby enabling the at least partly encloses the material to be removed.

According to one embodiment of the invention, said incipient cut extends along one of the elongated trench-like portions. Thereby, a large part of said at least one flat region is adapted to be removed.

According to one embodiment of the invention, said incipient cut forms at least one loop, wherein material located within the loop is adapted to be removed by means of the incipient cut. By means of the loop formed incipient cut a part of the material between a first side and a second side of the metal profile may be removed. Furthermore, the loop formed incipient cut may be arranged in a complex form that forms a complex remaining pattern on said at least one flat region.

According to one embodiment of the invention, the loop formed incipient cut is arranged to form a recession in the at least one flat region, which recession is arranged to accommodate the reception a fin structure for absorbing or radiate heat. The recession facilitates positioning of the fin structure on said at least one flat region.

According to one embodiment of the invention, said incipient cut intrudes a certain depth into the thickness of one of the first and the second metal profile, which depth is less than the thickness of the one of the first and the second metal profile along which the incipient cut extends. The intruding depth of the incipient cut is arranged so that the metal profile with the incipient cut is allowed to be handled and joined towards another metal profile without that the material at the incipient cut breaks and forms an edge.

According to one embodiment of the invention, said incipient cut intrudes from a top side and a lower side into the thickness of one of the first and the second metal profile.

According to one embodiment of the invention, an intruding part of the incipient cut, which intruding part intrudes the certain depth into the thickness of one of the first and the second metal profile, is provided intermittent along the extent of said incipient cut.

According to one embodiment of the invention, said intruding part intrudes fully through the thickness of one of the first and the second metal profile, wherein the intruding part is provided intermittent along the extent of said incipient cut.

According to one embodiment of the invention, the step c) comprises gripping a part of the material to be removed and pulling that part of the material in a direction along which the incipient cut extends. Accordingly, the incipient cut is adapted to allow the material at the incipient cut to break and form an edge when the material to be removed is being pulled.

According to one embodiment of the invention, said incipient cut is arranged on one of the first and the second metal profile.

According to one embodiment of the invention, wherein the first metal profile is joined to the second metal profile while forming a plurality of joints in said flat regions and said at least one flat region comprises a first joint adjacent to one of two adjacent channels and a second joint adjacent to the other of the two channels, wherein said incipient cut is adapted to be located between the first and the second joint. Accordingly, the incipient cut is arranged so that first and the second joint is maintained unaffected when removing the material from the at least one flat region.

According to one embodiment of the invention, the incipient cut is arranged at a distance from the first and the second joint so that the integrity of the joints are maintained when removing the material from the at least one flat region.

According to one embodiment of the invention, wherein the joining of the first metal profile to the second metal profile comprises clad-rolling the flat portions of the first metal profile towards the second metal profile. By means of clad-rolling the metal profiles are joined together in an efficient and costeffective manner.

According to one embodiment of the invention, wherein the second metal profile comprises a flat portion adapted to form said flat region.

According to one embodiment of the invention, wherein the second metal profile has a form corresponding to that of the first metal profile. The expression “a form corresponding to” refers to that the form of the second metal profile is substantially the same as the form of the first metal profile, and regardless if the second profile is provided with the incipient cut or not.

The object is further obtained by a channel arrangement according to the preamble of claim 11. The channel arrangement is characterized in that at least a part of one said flat region of the channel arrangement has a thickness being less than the sum of the thicknesses of the first and second metal profile by having material removed from one of the profiles on that location. Thereby, the material consumption and the weight of the channel arrangement are reduced in comparison to prior art channel arrangement.

According to one embodiment of the invention, said one flat region comprises a first joint adjacent to one of two adjacent channels and a second joint adjacent to the other of the two channels, wherein the arrangement comprises an edge between the first and the second joint, which edge was formed when removing material located at least partly enclosed by an incipient cut.

According to one embodiment of the invention, the first and the second metal profile consist of metal with high thermal conductivity. Preferably, the first and the second metal profile consist of copper or aluminum, or alloys thereof. By means of using a metal with high thermal conductivity in the metal profiles the heat conduction rate between the channels and the flat regions are high, which improves the efficiency when the channel arrangement is used in a heat exchanger.

According to one embodiment of the invention, the first and the second metal profile is adapted to form channels with circular cross section. The circular cross section of the channels enables a high pressure of the fluid to be conducted therein.

According to one embodiment of the invention, the material thickness of each of the first and the second metal profile is less than 1 mm, preferably less than 0.7 mm.

According to one embodiment of the invention, the material thickness of each of the first and the second metal profile is more than 0.3 mm, preferably more than 0.5 mm.

According to one embodiment of the invention, the first and the second metal profile is adapted to form channels with a cross section of less than 10 mm², preferably less than 7 mm².

According to one embodiment of the invention, the first and the second metal profile is adapted to form channels with a cross section of more than 3 mm², preferably more than 5 mm².

The object is further obtained by the use of a channel arrangement for conducting fluid in said channels thereof. According to one embodiment of the invention, the channel arrangement is used in a solar absorber.

The object is further obtained by a metal profile according to the preamble of claim 15, wherein one of said metal profiles comprises an incipient cut in at least one said flat portion.

### BRIEF DESCRIPTION OF THE DRAWINGS

The invention will now be explained more closely by the description of different embodiments of the invention and with reference to the appended figures.

FIG. 1a shows a metal profile comprising two incipient cuts.

FIG. 1b shows a detail view of the incipient cut in the encircled area of FIG. 1a.

FIG. 1c shows a metal profile comprising an incipient cut.

FIG. 2a shows a channel arrangement comprising a first and a second metal profile arranged toward each other and joined together.

FIG. 2b shows a channel arrangement comprising a first and a second metal profile arranged toward each other and joined together.

FIG. 2c shows a channel arrangement comprising a first and a second metal profile arranged toward each other and joined together.

FIG. 3a shows the channel arrangement in FIG. 2a having had material removed from the first metal profile.

FIG. 3b shows the channel arrangement in FIG. 2b having had material removed from the first metal profile.

FIG. 3c shows the channel arrangement in FIG. 2c having had material removed from the first metal profile.

FIG. 4 shows rolling mill for manufacturing a channel arrangement.

### DETAILED DESCRIPTION OF PREFERRED EMBODIMENTS OF THE INVENTION

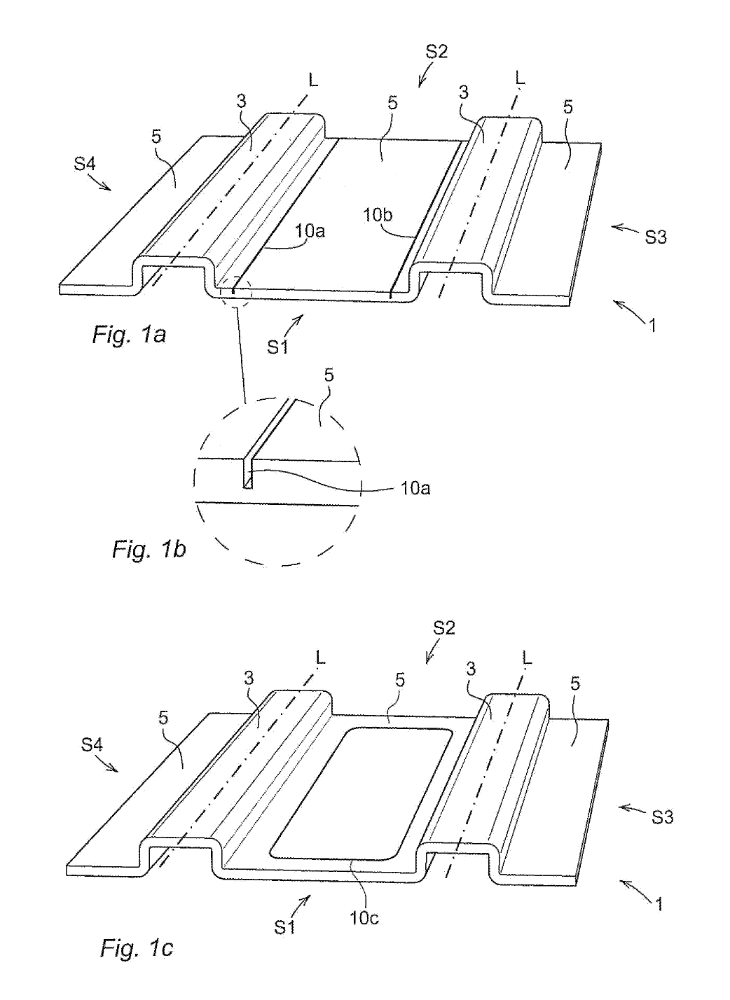

FIG. 1a shows a metal profile 1 seen from a side view. The metal profile 1 comprises two elongated trench-like portions 3 and three flat portions 5.

Each of the trench-like portions 3 comprises a longitudinal axis L. The flat portions 5 are located next to each side of the trench-like portions 3. The flat portions 5 extend along the longitudinal axis L of the trench-like portions 3.

One of the flat portions 5 is located between the two adjacent trench-like portions 3 and comprises a first incipient cut 10a and a second incipient cut 10b. The other two flat portions 5 are located on the opposite side of the respective trench-like portions 3.

The metal profile 1 has preferably been formed from a flat metal sheet. The thickness of the metal profile 1 is substantially uniform. Accordingly, the material thickness of the trench-like portions 3 and the flat portions 5 are essentially the same.

The metal profile 1 comprises four sides. The trench-like portions 3 extends from a first side S1 to a second side S2. The longitudinal axis of the trench-like portions 3 is perpendicular to the first side S1 and the second side S2, and parallel with a third side S3 and a fourth side S4 of the metal profile 1. In an embodiment the trench-like portions 3 extend a longer distance in comparison to the length of first side S1 and the second side S2.

FIG. 1b shows a detail view of the first incipient cut 10a in the encircled area of FIG. 1a. The first incipient cut 10a intrudes a certain depth laterally into the metal profile 1. The intruding depth is less than the thickness of the metal profile 1.

The incipient cut 10a, 10b provides a weakening in the metal profile 1 that enables material between the first incipient cut 10a and the second incipient cut 10b to be removed. Upon removal of the material between the first incipient cut 10a and the second incipient cut 10b an edge is adapted to be formed, which edge extends along the length of the first incipient cut 10a and the second incipient cut 10b.

FIG. 1c shows a side view of a metal profile 1 having the same form as the metal profile 1 in FIG. 1a. The metal profile 1 comprises an incipient cut 10c located in the flat portion between the two trench-like portions 3. The incipient cut 10c extends in a loop, wherein material enclosed within the incipient cut 10c is adapted to be removed.

The incipient cut 10c provides a weakening in the metal profile 1 that enables material enclosed by the incipient cut 10c to be removed. Upon removal of the material enclosed by the incipient cut 10c an edge is adapted to be formed, which edge extends along the length of the incipient cut 10c.

According to an embodiment of the invention the metal profile 1 comprises one or more loop formed incipient cuts 10c at the flat portions 5 of the metal profile 1. The one or more loop formed incipient cuts 10c enables one or more of the enclosed material to be removed.

The metal profile 1 in FIG. 1a-1c are adapted to be arranged towards and joined to another metal profile 1, and thereby forming a channel arrangement with channels defined between the two metal profiles 1. The material at least partly enclosed between the incipient cuts 10a, 10b, 10c is adapted to be removed. The flat portions 5 of the metal profile 1 and the other metal profile 1 are adapted to form flat regions. The channels of the channel arrangement are adapted to conduct a fluid. The flat regions of the channel arrangement are adapted to conduct heat to or from the channels.

It shall be understood that the metal profiles 1 in FIG. 1a-1c are not restricted to two trench-like portions 3 but the metal profiles 1 may comprise any number in plurality of trench-like portions 3 that are mutually separated by flat portions 5. Accordingly, it is possible to produce a channel arrangement comprising a large number of channels. Furthermore, it shall be understood that one or more of the flat portions 5 comprises the incipient cut 10a, 10b, 10c that enables removal of material.

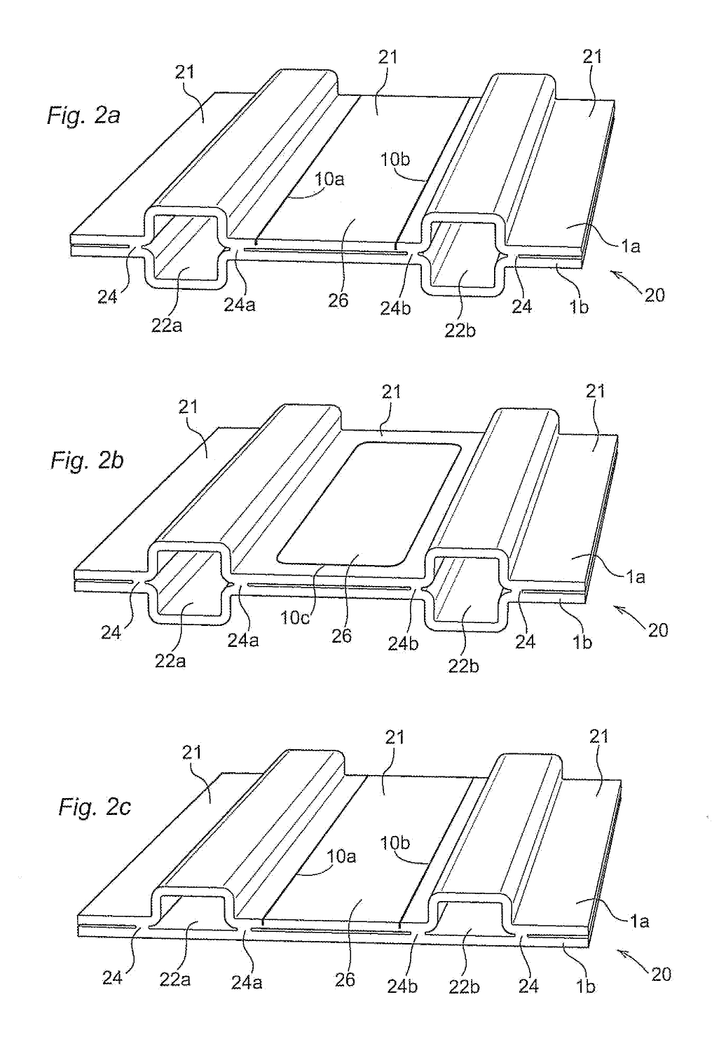

FIG. 2a shows a channel arrangement 20 comprising a first metal profile 1a and a second metal profile 1b arranged toward each other and joined together.

The first metal profile 1a and the second metal profile 1b have the form of the metal profile 1 disclosed in FIGS. 1a and 1b. Accordingly, the profiles 1a, 1b comprises the plurality of trench-like portions 3 and plurality of flat regions 21.

The first metal profile 1a comprises the first incipient cut 10a and the second incipient cut 10b located in the flat region 21 between the two trench-like ridges 3. The second metal profile 1b lacks incipient cut.

The first metal profile 1a and the second metal profile 1b have been arranged so that the flat portions 5 of the first metal profile 1a and the second metal profile 1b abut each other and so that the trench-like portions 3 are directed in opposite directions, wherein the profiles 1a, 1b defines a first channel 22a and a second channel 22b between the profiles. The channels 22a, 22b are adapted to conduct a fluid.

The channel arrangement 20 comprises a plurality of joints 24 located in the flat regions 21 between the first metal profile 1a and the second metal profile 1b. The joints 24 are arranged adjacent to each side of the channels 22a, 22b.

The joints 24 are adapted to hold the first metal profile 1a and the second metal profile 1b together. Furthermore, the joints 24 are adapted to have sufficient strength to maintain a certain pressure of the fluid without leakage.

The joints 24 comprise a first joint 24a adjacent to the first channel 22a and a second joint 24b adjacent to the second channel 22b. The first incipient cut 10a and the second incipient cut 10b are arranged between the first joint 24a and the second joint 24b. The first incipient cut 10a and the second incipient cut 10b is adapted to enable removal of material 26 from the flat region 21 between the first channel 22a and the second channel 22b.

FIG. 2b shows a channel arrangement 20 comprising a first metal profile 1a and a second metal profile 1b arranged toward each other and joined together. The first metal profile 1a in FIG. 2b is the first metal profile 1a in FIG. 1c. The second metal profile 1b has the same form as the first metal profile 1a but lacks the incipient cut.

By means of the incipient cut 100c in the first metal profile 1a, material enclosed by the loop formed incipient cut 10c is adapted to be removed from the channel arrangement 20.

FIG. 2c shows a channel arrangement 20 comprising a first metal profile 1a and a second metal profile 1b arranged toward each other and joined together.

The first metal profile 1a in FIG. 2c is the first metal profile 1a from FIG. 1a. Accordingly, the first metal profile 1a comprises the plurality of trench-like portions 3 and plurality of flat regions 21. The second metal profile 1b comprises a flat sheet of metal. Accordingly, the second metal profile 1b lacks the trench-like portions 3. The second metal profile 1b lacks the incipient cut.

The first metal profile 1a and the second metal profile 1b define channels 22a, 22b. The cross section of the channels in FIG. 2c is half of the cross section of the channels 22a, 22b in FIG. 2a.

It shall be understood that a single profile with trench-like portions 3 and flat portions 5 and another profile comprising at least flat portions 5 arranged towards each other are sufficient in order to define the channels 22a, 22b of the channel arrangement 20. Furthermore, the incipient cut 10a, 10b, 10c for removal of material may be arranged in either the first metal profile 1a or the second metal profile 1b.

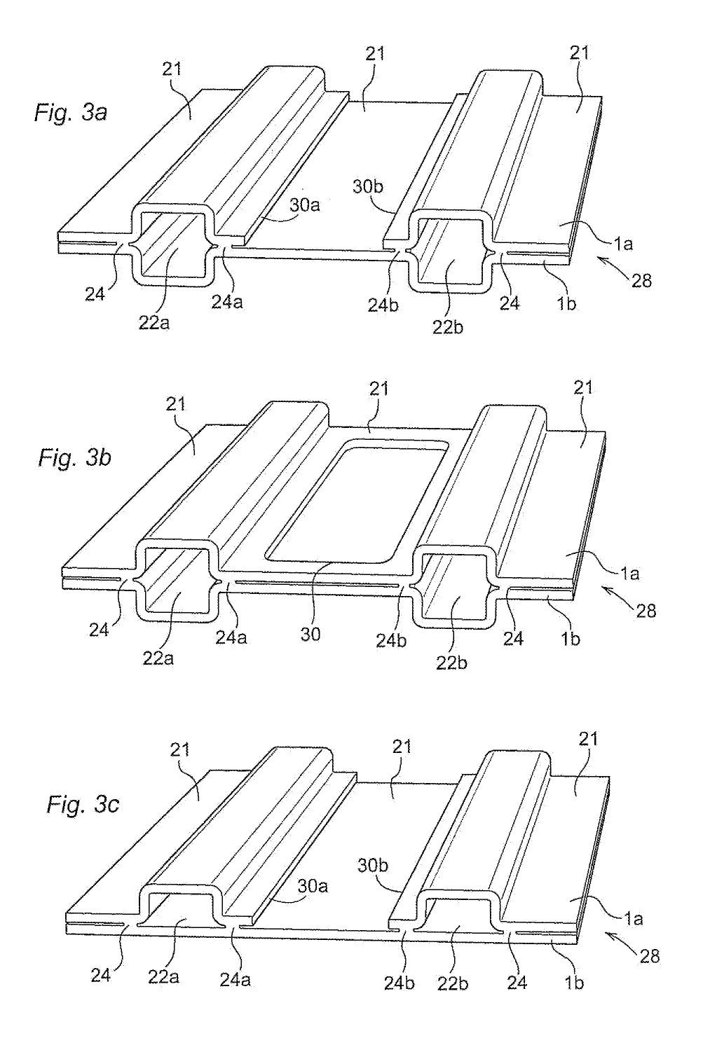

FIG. 3a shows the channel arrangement 28 in FIG. 2a having had the material between the first incipient cut 10a and the second incipient cut 10b removed from the first metal profile 1a.

By means of the removal of the material 26, the thickness of the flat region 21 between the first channel 22a and the second channel 22b of the channel arrangement has been reduced by the thickness of the first metal profile 1a, wherein the thickness of a part of the flat region 21 has the thickness of the second metal profile 1b.

As the material was removed from the flat region 21, the first incipient cut 10a formed a first edge 30a and the second incipient cut 10b formed a second edge 30b. Each of the first edge 30a and the second edge 30b extends along the respective first incipient cut 10a and second incipient cut 10b.

By means of the removal of material 26 from the flat region 21 the material consumption of the channel arrangement 28 is reduced. Moreover, the weight of the channel arrangement 28 is reduced.

FIG. 3b shows the channel arrangement in FIG. 2b having had material 26 removed from the first metal profile 1a. The material 26 removed was enclosed by the loop formed incipient cut 10c, wherein a corresponding loop formed edge 30 was formed.

FIG. 3c shows the channel arrangement in FIG. 2c having had material 26 removed from the first metal profile 1a. The material 26 that was located between the first incipient cut 10a and the second incipient cut 10b has been removed from the first metal profile 1a.

The channel arrangement 28 in FIG. 3a-3c is adapted to be used in a heat exchanger, preferably a solar absorber. By means of reducing the material consumption the cost of the heat exchanger is reduced.

It shall be understood that the channel arrangement 20 in FIG. 2a-2c and the channel arrangements 28 in FIG. 3a-3c are not restricted to two channels but the channel arrangement may comprise any number in plurality of channels that are separated by flat regions 21. Accordingly, it is possible to produce channel arrangements 20, 28 comprising a large number of channels 22a, 22b.

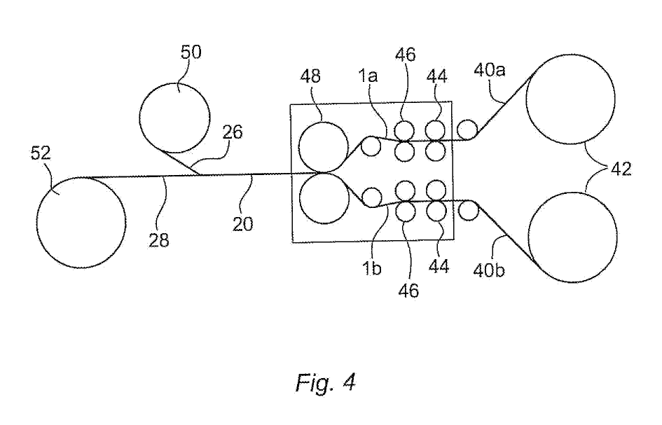

FIG. 4 shows a rolling mill 35 adapted to be used in the method for producing a channel arrangement 28 from a first metal profile 1a and a second metal profile 1b.

In a first step, the process comprises forming the first metal profile a and the second metal profile 1b. A first metal sheet 40a and a second metal sheet 40b are provided from first pair of collecting rolls 42 to a respective first pair of rolls 44, which rolls 44 are adapted to form the first metal sheet 40a and the second metal sheet 40b into the first metal profile 1a and the second metal profile 1b. The first pair of rolls 44 comprises protrusions and recessions that are adapted to form the trench-like portions 3 and the flat portions 5 of the first metal profile 1a and the second metal profile 1b.

In a second step, the process comprises forming incipient cut 10a, 10b, 10c in at least one of the first metal profile 1a and the second metal profile 1b. The first metal profile 1a and the second metal profile 1b is provided to a respective second pair of rolls 46, which rolls 46 are adapted to form the incipient cut 10a, 10b, 10c. The second pair of rolls 46 comprises cutting means adapted to cut into a part of the thickness of the at least one of the first metal profile 1a and the second metal profile 1b.

In a third step, the process comprises a) arranging the first metal profile 1a towards a second metal profile 1b so that trench-like portions 3 of the first metal profile 1a are directed away from trench-like portions 3 of the second metal profile 1b and flat portions 5 of the first metal profile 1a are abutting flat portions 5 of the second metal profile 1b.

In a forth step, the process comprises b) joining the metal profiles 1a, 1b so that channels 22a, 22b between the profiles 1a, 1b are formed, which channels extends according to the trench-like portions 3 of at least one of the first metal profile 1a and the second metal profile 1b. The joining of the metal profiles 1a, 1b comprises providing the first metal profile 1a and the second metal profile 1b to a third pair of rolls 48 that form a plurality of joints 24 at flat regions 21 on each side of the channels 22a, 22b.

In a fifth step, the process comprises c) gripping a part of the material 26 to be removed and pulling a part of the material 26 in a direction along which the incipient cut 10a, 10b, 10c extends, wherein the material 26 is removed from the flat region 21 so that the thickness of the flat region 21 becomes less than the sum of the thickness of the first metal profile 1a and the second metal profile 1b. The material 26 to be removed is gripped and provided to a second collecting roll 50.

In a sixth step, the process comprises collecting the produced channel arrangement 28 on a second collecting roll 52.

The disclosed process in FIG. 4 enables the channel arrangement 28 to be produced in a continuous manner. Accordingly, the channel arrangement 28 can be produced in a cost effective manner with reduced material consumption.

The present invention is not limited to the embodiments disclosed but may be varied and modified within the scope of the following claims.

For example, the channels 22a, 22b may have any type of form, such as circular cross section, rectangular cross section, etcetera. One and the same channel arrangement may also have channels with different shapes and/or cross section area. The joints 24, 24a, 24b may be arranged by various methods, such as welding, bracing, rolling, etcetera.

The incipient cut 10a, 10b, 10c may have various configurations, such as continuously or intermittent extending along the material 26 that is adapted to be removed from the at least one flat region 21. The incipient cut 10a, 10b, 10c may partly or completely enclosing one or more material 26 that is adapted to be removed from the at least one flat region 21.

1. A method for producing a channel arrangement, the method comprising:
arranging a first metal profile towards a second metal profile, said first metal profile comprising elongated trench-like portions mutually separated by flat portions,
joining the first metal profile to the second metal profile so that channels between these profiles are defined, which channels extend according to said trench-like portions, said channels being separated by flat regions, and wherein in the arranging at least one of said profiles is a profile comprising an incipient cut to be located in at least one said flat region, and
removing material from said at least one flat region utilizing said incipient cut, so that a thickness of at least a part of said at least one flat region becomes less than the sum of the thicknesses of the first metal profile and the second metal profile.

2. The method for producing a channel arrangement according to claim 1, wherein said incipient cut at least partly encloses the material to be removed.

3. The method for producing a channel arrangement according to claim 1, wherein said incipient cut extends along one of the elongated trench-like portions.

4. The method for producing a channel arrangement according to claim 1, wherein said incipient cut intrudes a certain depth into the thickness of one of the first metal profile and the second metal profile, which depth is less than the thickness of the one of the first metal profile and the second metal profile along which the incipient cut extends.

5. The method for producing a channel arrangement according to claim 1, wherein the removing material comprises gripping a part of the material to be removed and pulling the gripped part of the material in a direction along which the incipient cut extends.

6. The method for producing a channel arrangement according to claim 1, wherein said incipient cut is arranged on one of the first metal profile and the second metal profile.

7. The method for producing a channel arrangement according to claim 1, wherein the first metal profile is joined to the second metal profile while forming a plurality of joints in said flat regions and said at least one flat region comprises a first joint adjacent to one of two adjacent channels and a second joint adjacent to the other of the two channels, wherein said incipient cut is adapted to be located between the first joint and the second joint.

8. The method for producing a channel arrangement according to claim 1, wherein the joining of the first metal profile to the second metal profile comprises clad-rolling the flat portions of the first metal profile towards the second metal profile.

9. The method for producing a channel arrangement according to claim 1, wherein the second metal profile comprises a flat portion adapted to form said flat region.

10. The method for producing a channel arrangement according to claim 1, wherein the second metal profile has a form corresponding to that of the first metal profile.

11. A channel arrangement, comprising:
a first metal profile having a plurality of elongated trench-like portions mutually separated by flat portions, and
a second metal profile joined to said first metal profile while defining channels between these profiles extending according to said trench-like portions,
wherein said channels being are separated by flat regions, and
wherein at least a part of one said flat region of the channel arrangement has a thickness being less than the sum of the thicknesses of the first metal profile and second metal profile by having material removed from one of the profiles on that location.

12. The channel arrangement according to claim 11, wherein said one flat region comprises a first joint adjacent to one of two adjacent channels and a second joint adjacent to the other of the two channels, wherein the arrangement comprises an edge between the first joint and the second joint, which edge was formed when removing material located at least partly enclosed by an incipient cut.

13. The method according to claim 1, further comprising:
conducting fluid in said channels thereof.

14. The method according to claim 1, further comprising:
incorporating the channels in a solar absorber.

15. A couple of metal profiles, in which a first of the profiles comprises a plurality of elongated trench-like portions mutually separated by flat portions, wherein the first metal profile is adapted to be arranged towards and joined to the other second metal profile while defining channels between these profiles extending according to said trench-like portions and said channels being separated by flat regions,
wherein one of said metal profiles comprises an incipient cut in at least one said flat portion.
